(19) United States
(12) Patent Application Publication
(10) Pub. No.: US 2016/0213108 A1
(43) Pub. Date: Jul. 28, 2016

(54) CLAMP UMBRELLA

(71) Applicant: ROBYN ISOM, CAMPBELL, CA (US)

(72) Inventor: ROBYN ISOM, CAMPBELL, CA (US)

(21) Appl. No.: 15/004,765

(22) Filed: Jan. 22, 2016

Related U.S. Application Data
(60) Provisional application No. 62/107,189, filed on Jan. 23, 2015.

(51) Int. Cl. A45B 9/02; F16C 11/04; A45B 25/00; F16B 2/06

(52) U.S. Cl. CPC A45B 9/02; F16B 2/06; F16C 11/04; A45B 25/00; A45B 2025/003

(57) ABSTRACT

The present invention relates generally to the field of umbrellas and more specifically relates to a clamp umbrella. The new hands-free umbrella is designed to be attractive and practical by incorporating the new functionality into the general size and position of an umbrella handle while maintaining the design and function of the umbrella rod and dome.

### CROSS-REFERENCE TO RELATED APPLICATIONS

This application claims the benefit of U.S. Provisional Application for Patent Ser. No. 62/107,189, filed on Jan. 23, 2015.

### BACKGROUND OF THE INVENTION

The present invention relates generally to the field of umbrellas and more specifically relates to a clamp umbrella. The new hands-free umbrella is designed to be attractive yet practical by incorporating a new clamping functionality into the general size and position of an umbrella handle while maintaining the design and function of the traditional umbrella shaft and dome.

Rain can make simple chores, like grocery shopping or taking a baby for a walk in the stroller, much more complicated. For example, it is difficult to load groceries and the baby into the car while holding an umbrella with one hand. While carrying an umbrella, it can be arduous to navigate a cart or a stroller, whether moving straight ahead or maneuver around obstructions. In similar scenarios, construction workers on job sites have a need to carry umbrellas when they require both hands to load or unload equipment and materials, and sales personnel and business people loading or unloading samples and supplies from their vehicles on rainy days need to stay dry and presentable.

The new clamp umbrella addresses these challenges with a simply yet innovative improvement on the time-honored umbrella. Other inventions geared toward umbrella independence attempt to accomplish basic hands-free umbrella support, but these devices are designed to be semi-permanently attached to an object such that the user cannot easily reposition or remove the umbrella clamp. These devices also generally require use of the user's own umbrella such that repositioning or removal requires management of two separate devices. The device disclosed in U.S. patent application no. US 2010/0071737 A, for example, holds an umbrella to shield a user from rain while freeing the user's hands to drive a golf cart. While effective for a limited purpose, this device requires the use of both the holder and a separate umbrella and necessitates disassembly to remove or reposition it. Likewise, the adjustable beach chair disclosed in U.S. Pat. No. 6,234,187 B1 is limited in functionality, as it can only be attached to the top frame of a beach chair. It is clear, the need remains to simply and inexpensively solve these problems, and the new, reliable clamp umbrella does exactly that.

### SUMMARY OF THE INVENTION

In view of the foregoing disadvantages inherent in the known art, the present invention provides a novel umbrella-securing means. The general purpose of the present invention is to enable a user to benefit from the inherent advantages of a traditional umbrella with the additional convenience of having one's hands free to perform everyday tasks.

The new clamp umbrella provides a way to secure an umbrella in a workable position to nearby objects so users can have both hands free while being protected from the rain. The sum of these objectives—including associated advantages—unifies with the novel article of the clamp umbrella, resulting in an invention that is not anticipated, rendered obvious, suggested, or even implied by any of the prior art support, either alone or in any combination thereof. These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

FIG. 1 shows a perspective view of one embodiment of the clamp umbrella with its shaft in line with the handle axis.

FIG. 2 shows the front view of the handle of one embodiment of the clamp umbrella in closed position.

FIG. 3 shows a perspective view of the handle of one embodiment of the clamp umbrella in open position.

FIG. 4 shows a perspective view of the handle of one embodiment of the clamp umbrella in closed position while attached to a stroller handle.

FIG. 5 shows a perspective view of one embodiment of the clamp umbrella while attached to the armrest of a lounge chair.

FIG. 6 shows a perspective view of one embodiment of the clamp umbrella while attached to the top of an open car door.

FIG. 7 shows a perspective view of one embodiment of the clamp umbrella while attached to a grocery cart.

### DESCRIPTION OF THE INVENTION

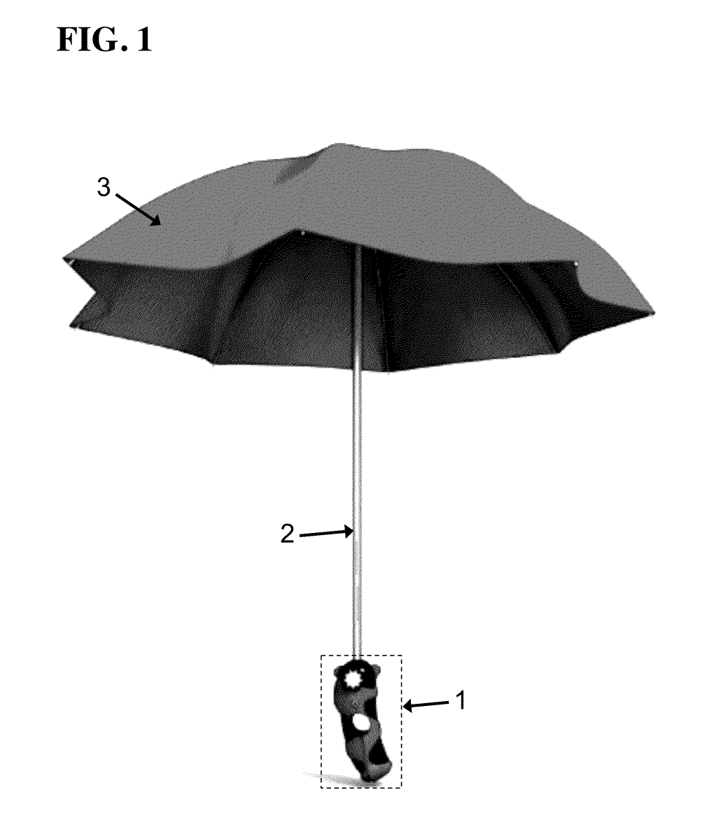

The figures accompanying the written this specification illustrate embodiments of the present invention, the new clamp umbrella, constructed and operative according to the teachings of the present invention. FIGS. 1-7 show various perspective views and uses illustrating one embodiment of the clamp umbrella. As discussed above, embodiments of the present invention relate to an umbrella securing means and more particularly to a clamp umbrella.

FIG. 1 shows a perspective view of one embodiment of the clamp umbrella with its shaft 2 in line with the handle 1 axis. The new stylish and functional clamp umbrella has a handle 1 that can be opened to clip or clamp the umbrella onto a solid surface so it will stay erect and provide the user with protection from rain even when not being held by the user.

The handle 1 is connected to an umbrella shaft 2, which can be designed with telescoping functionality to enable compact storage or as a single elongated, rigid piece for structural integrity. The shaft 2 is connected to the dome 3, which can be opened to shield the user from wind and rain and collapsed for storage just like the dome of a regular umbrella.

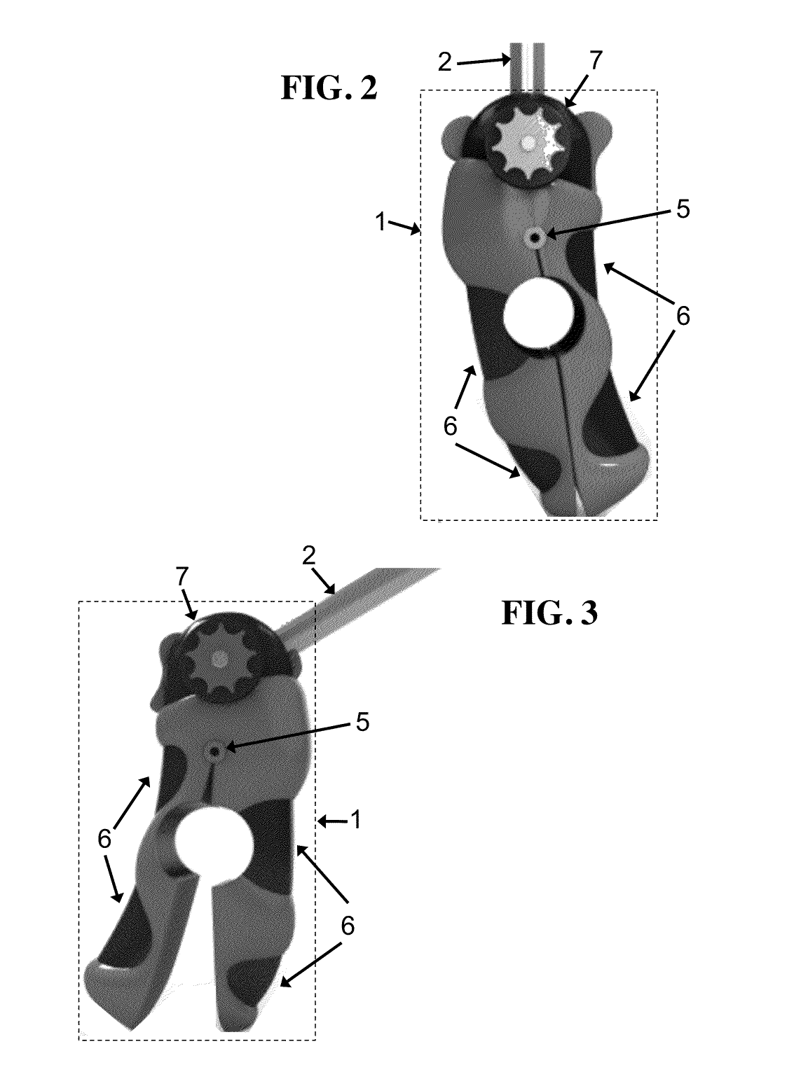

FIG. 2 shows the front view of the handle 1 of one embodiment of the clamp umbrella in closed position. The handle 1 of the new clamp umbrella is generally comprised of two elongated clamp members 4 connected at their top ends by a hinge 5 that enables the bottom ends of clamp members 4 to come to together or be moved apart in the same manner as a clamp (or clip), similar to an alligator clamp. The clamp members 4 can be opened and clamped on or around a solid surface to support the umbrella in an upright or tilted position when the user needs free use of both hands while being shielded from the rain by the umbrella. The clamp members 4 of the handle 1 have outer finger grooves 6 to make it comfortable when carrying the umbrella in one's hand. At the top of the handle 1, above the hinge 5, is a pivot joint 7 that attaches at its top to the shaft 2 and enables rotation of the shaft 2 about the axis of the handle 1.

FIG. 3 shows a perspective view of the handle 1 of one embodiment of the clamp umbrella in open position. There is a pivot joint 7 just above the hinge 5 so the shaft 2 can be tilted, as shown, to provide the user with maximum protection from the rain.

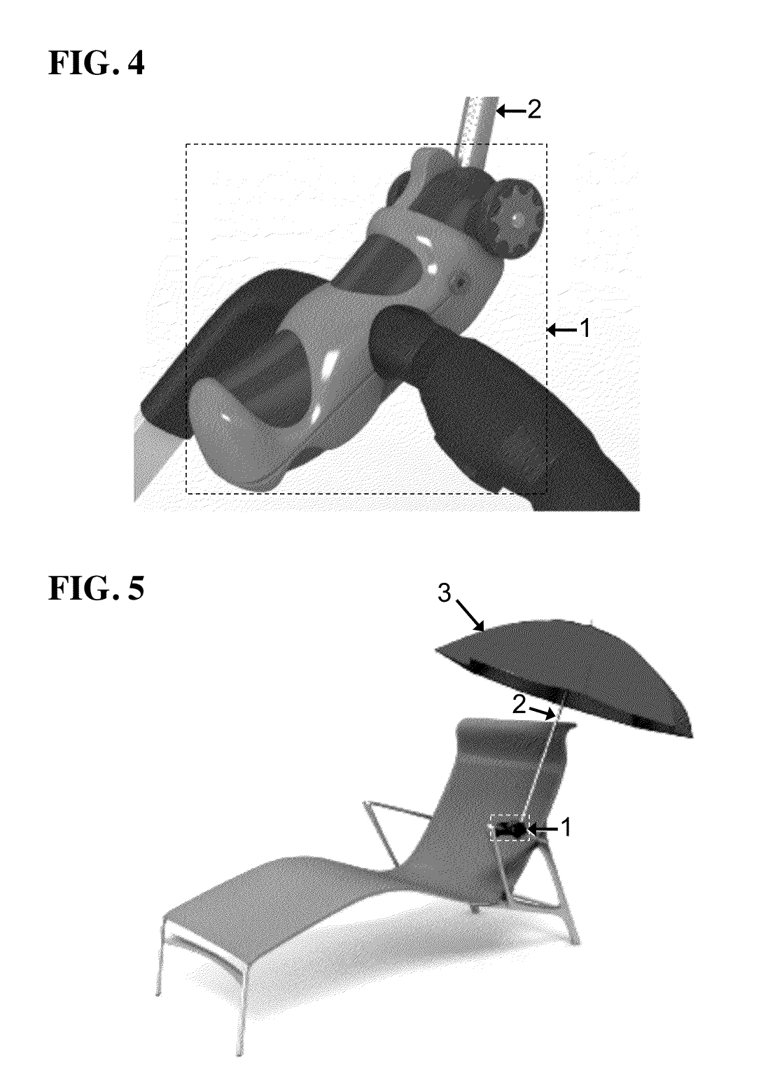

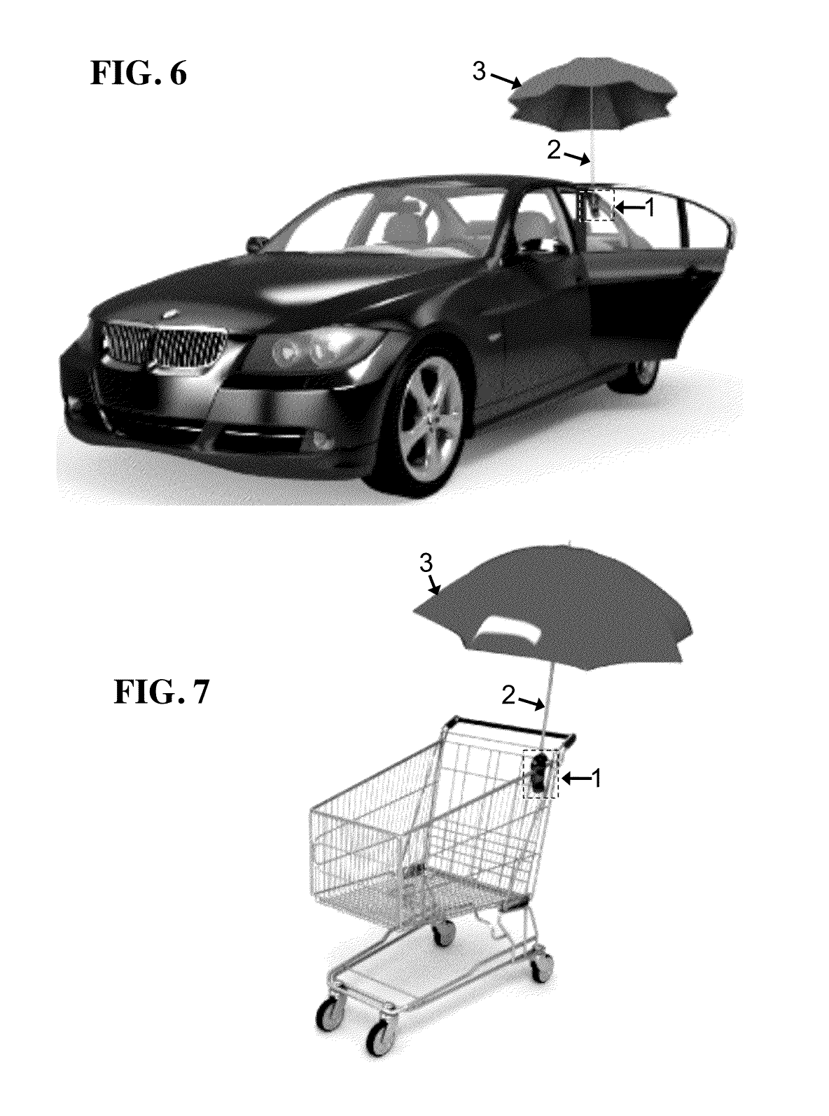

FIG. 4 shows a perspective view of the handle of one embodiment of the clamp umbrella in closed position while attached to a stroller handle. FIG. 5 shows a perspective view of one embodiment of the clamp umbrella while attached to the armrest of a lounge chair. FIG. 6 shows a perspective view of one embodiment of the clamp umbrella while attached to the top of an open car door. FIG. 7 shows a perspective view of one embodiment of the clamp umbrella while attached to a grocery cart.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a clamp umbrella that:
Provides a way to secure an umbrella so users can have free use of both hands;
Is attractive and comfortable when held in one's hand;
Can be clamped to the handle of a grocery cart or a stroller, so it can be pushed easily with both hands while protecting the user from the rain;
Can be clamped to a door jam or the edge of a car's trunk while the user is loading and unloading groceries and the like;
Allows the user to secure the umbrella in a workable position so it will provide protection from the rain; and
Will protect parents and other users from being undesirably soaked as they perform jobs in the rain, sleet or snow that required the use of both hands.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided. The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An adjustable clamp umbrella apparatus, comprising:
a shaft having two ends;
a dome portion located at one end of said shaft, said dome being movable between an open position where the dome portion extends generally radially outward from said shaft and a closed position where the dome portion is collapsed against said shaft; and
a handle located at the opposite end of said shaft, said handle comprising:
two clamp members having inner and outer surfaces, said outer surfaces having finger grooves and said inner surfaces being coated with slip-resistant polymer substance and having a concave portion, each said clamp member being generally elongated with a top end and a bottom end and attached to the other clamp member near the top end by a hinge, said hinge being spring loaded and enabling the bottom end of each clamp member to be brought together, in resting position, or apart, in open position;
two hinge release tabs, one located at the top of each clamp member above the hinge and positioned opposite each other such that squeezing said tabs together causes the bottom ends of the clamp members to move from closed position to open position; and
and a pivot joint located above the hinge, said pivot joint connecting the handle to the shaft, and said pivot joint enabling the connected shaft to be tilted at an angle relative to the handle.
